(19) United States
(12) Patent Application Publication
(10) Pub. No.: US 2025/0322192 A1
(43) Pub. Date: Oct. 16, 2025

(54) IMAGE FORMING APPARATUS AND COLORIMETRY METHOD

(71) Applicant: Konica Minolta, Inc., Tokyo (JP)

(72) Inventor: Moethettin Sandar, Tokyo (JP)

(73) Assignee: Konica Minolta, Inc., Tokyo (JP)

(21) Appl. No.: 19/174,142

(22) Filed: Apr. 9, 2025

(30) Foreign Application Priority Data
Apr. 10, 2024 (JP) 2024-063392

(51) Int. Cl. G06K 15/02; B41J 2/21; B41J 11/00; B41J 13/10; G06K 15/10

(52) U.S. Cl. CPC G06K 15/027; B41J 2/2135; B41J 11/002; B41J 13/106; G06K 15/102

(57) ABSTRACT

Provided is an image forming apparatus including an image forming unit, a colorimetry unit, and a hardware processor. The image forming unit forms an image on a medium with a photocurable ink. The colorimetry unit performs colorimetry of a colorimetry chart formed on the medium by the image forming unit. The hardware processor causes the colorimetry of the colorimetry chart to be performed after elapse of a color change time since irradiation of the colorimetry chart with light.

### CROSS-REFERENCE TO RELATED APPLICATIONS

The entire disclosure of Japanese Patent Application No. 2024-063392 filed on Apr. 10, 2024, is incorporated herein by reference in its entirety.

### BACKGROUND OF THE INVENTION

### Technical Field

The present invention relates to an image forming apparatus and a colorimetry method.

### Description of Related Art

Conventionally, an image forming apparatus provided with a colorimetric device for color calibration or the like is known. For example, the image forming apparatus of Japanese Unexamined Patent Publication No. 2023-85122 performs colorimetry after fixing and cooling an image for measurement. Cooling is said to be effective as a means of avoiding the effects of thermochromism.

To solve the problem in which an image formed on a medium using a photo-curable ink causes color change of the image even if the temperature is not high. The color change of the image is due to the reaction of a photopolymerization initiator. Although this color change requires time to stabilize, colorimetry is conventionally performed before the color change stabilizes. Therefore, even if colorimetry and color adjustment are performed using a colorimetric chart, advanced color adjustment cannot be performed.

The present invention has been made in order to solve the above-described problem, and an object of the present invention is to provide an image forming apparatus, a colorimetry method, and a storage medium storing a colorimetry program which are capable of improving colorimetry accuracy of a colorimetry chart formed with a photocurable ink.

### SUMMARY OF THE INVENTION

To achieve at least one of the abovementioned objects, according to an aspect of the present invention, an image forming apparatus reflecting one aspect of the present invention includes:
an image forming unit that forms an image on a medium with a photocurable ink;
a colorimetry unit that performs colorimetry of a colorimetry chart formed on the medium by the image forming unit; and
a hardware processor that causes the colorimetry of the colorimetry chart to be performed after elapse of a color change time since irradiation of the colorimetry chart with light.

According to another aspect of the present invention, provided is a colorimetry method of performing colorimetry of a colorimetry chart formed on a medium with a photocurable ink, including:
irradiating the colorimetric chart with light;
causing the medium to stand by for a standby time set in advance so as to correspond to a color change time from the irradiation of the colorimetry chart; and
performing colorimetry of the colorimetry chart after lapse of the standby time.

According to another aspect of the present invention, provided is a colorimetry method of performing colorimetry of a colorimetry chart formed on a medium with a photocurable ink, including:
irradiating the colorimetric chart with light;
acquiring a change in a colorimetric value of a same patch of at least part of the colorimetry chart by repeatedly performing colorimetry on the same patch; and
performing colorimetry of the colorimetry chart after the change in the colorimetric value reaches a predetermined range.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic diagram showing an overall configuration of an image forming apparatus according to an embodiment of the present invention.

FIG. 2 is a front view of a medium on which a colorimetry chart according to a first embodiment of the present invention is formed.

FIG. 3 is a graph showing a change in color of a photocurable ink after light irradiation.

FIG. 4 is a flowchart showing a flow of a colorimetry method in the image forming apparatus according to the first embodiment of the present invention.

FIG. 5 is a front view of a medium on which a colorimetry chart according to a second embodiment of the present invention is formed.

FIG. 6 is a flowchart showing a flow of a colorimetry method in the image forming apparatus according to the second embodiment of the present invention.

### DETAILED DESCRIPTION

Hereinafter, one or more embodiments of the present invention will be described with reference to the drawings. However, the scope of the invention is not limited to the disclosed embodiments.

### First Embodiment

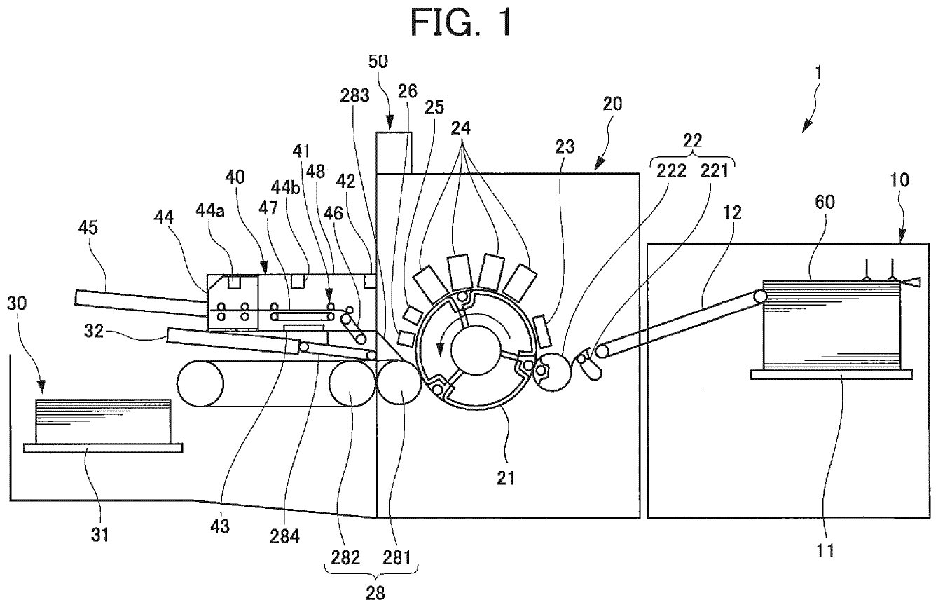

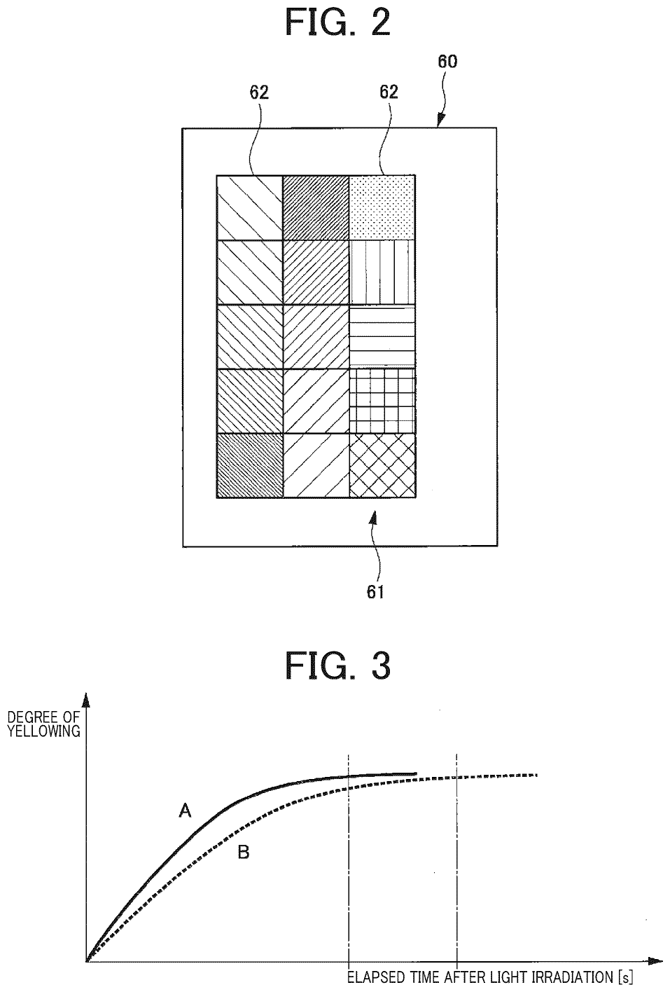

FIG. 1 is a schematic diagram showing a configuration of an inkjet-type image forming apparatus according to an embodiment. FIG. 2 is a front view of a medium 60 on which a colorimetry chart is formed by the image forming apparatus.

The image forming apparatus 1 includes a sheet feeding unit 10, an image forming unit 20, an ejection unit 30, a colorimetry unit 40, and a controller 50 (hardware processor).

The sheet feeding unit 10 includes a sheet feed tray 11 and a medium feed section 12. The sheet feed tray 11 stores media 60. The medium feed section 12 conveys and feeds the medium 60 from the sheet feed tray 11 to the image forming unit 20.

The medium feed section 12 includes a ring-shaped belt whose inner side is supported by two rollers. The medium feed section 12 conveys the medium 60 from the sheet feed tray 11 to the image forming unit 20 by rotating the rollers in a state where the medium 60 is placed on the belt.

The image forming unit 20 forms an image on the medium 60 with photocurable ink. The photocurable ink to be used is ink containing a photopolymerization initiator. The photocurable ink changes its color due to a curing reaction of the photopolymerization initiator. This color change becomes stable over time.

In addition, the image forming unit 20 forms an image of a colorimetry chart on a medium 60 at the timing of performing colorimetry. The colorimetry chart 61 includes a large number of patches 62 to be subjected to colorimetry. The colorimetry chart 61 may include the patches 62 of all the colors included in the image data. The colorimetry chart 61 of the present embodiment includes a large number of rectangular patches 62 arranged in the vertical and horizontal directions in a matrix.

Back in FIG. 1, the image forming unit 20 includes a conveyance drum 21, a handover unit 22, a heating section 23, head units 24, a fixing section 25, an imaging section 26, and a delivery section 28.

The conveyance drum 21 is formed in a columnar shape. The outer peripheral surface of the conveyance drum 21 serves as a conveyance surface on which the medium 60 is placed. The conveyance drum 21 rotates in the direction of the arrow in FIG. 1 while holding the medium 60 on the transport surface. The conveyance drum 21 thereby conveys the medium 60 along the conveyance surface.

The handover unit 22 includes a swing arm 221 and a handover drum 222. The handover unit 22 is disposed between the medium feed section 12 of the sheet feeding unit 10 and the conveyance drum 21. The handover unit 22 holds and picks up the medium 60 conveyed from the medium feed section 12 with the swing arm 221, and then hands over the medium 60 to the conveyance drum 21 via the handover drum 222.

The heating section 23 is disposed between the handover drum 222 and the head units 24. The medium 60 held by the conveyance drum 21 is heated so as to be within a predetermined temperature range. The heating section 23 includes, for example, an infrared heater.

The head units 24 include a plurality of inkjet heads that eject photocurable ink.

The head units 24 eject photocurable ink onto the medium 60 at appropriate timings in accordance with the rotation of the conveyance drum 21 on the basis of the image data to form an image. The head units 24 are disposed at a predetermined distance with the ink ejection faces facing the conveyance drum 21.

The image forming apparatus 1 according to the present embodiment includes a plurality of head units 24 corresponding to four color inks of yellow (Y), magenta (M), cyan (C), and black (K). The plurality of head units 24 are arranged in order of colors of Y, M, C, and K from the upstream side in the conveyance direction of the medium 60.

The fixing section 25 includes a light emitter disposed across the width direction of the conveyance drum 21 (the height direction of the cylindrical shape). The fixing section 25 emits energy beams, such as ultraviolet rays, onto the medium 60 placed on the conveyance drum 21, to cure and fix the photocurable ink on the medium 60.

The imaging section 26 images the surface of the medium 60 on the downstream side of the head units 24 and the fixing section 25 in the conveyance direction on the conveyance path, and outputs the image as read data to the controller 50. The imaging section 26 includes a plurality of line sensors. The line sensor may be, for example, a CMOS sensor.

The delivery section 28 is an ejection path for the medium 60 on which an image has been formed. The delivery section 28 is provided between the image forming unit 20 and the ejection unit 30. The delivery section 28 includes a belt loop 282 and a handover drum 281. The belt loop 282 includes a ring-shaped belt supported by two rollers. The handover drum 281 has a cylindrical shape, and hands over the medium 60 from the conveyance drum 21 to the belt loop 282.

The delivery section 28 conveys the medium 60 handed over from the conveyance drum 21 onto the belt loop 282 by the handover drum 281, and ejects the medium 60 to the ejection unit 30.

The delivery section 28 according to the present embodiment includes a switching section 283 on the downstream of the handover drum 281. The switching section 283 switches a destination to which the medium 60 is sent from the image forming unit 20.

The switching section 283 alternatively switches the destination to which the medium 60 is to be sent among the ejection unit 30, the first sampling tray 32, and the colorimetry unit 40. During normal image formation, the ejection destination of the switching section 283 is the ejection unit 30. In this case, the switching section 283 sends the medium 60 to the belt loop 282.

Furthermore, the switching section 283 can take out a part of the media 60 and eject it to the first sampling tray 32, separately from the media 60 ejected to the ejection unit 30. That is, the switching section 283 can send the medium 60 to the belt loop 284 continuous with the first sampling tray 32 by switching the sending destination.

When the colorimetry of the colorimetry chart 61 is performed, the switching section 283 sends the medium 60 on which the colorimetry chart 61 is formed to the colorimetry unit 40.

The ejection unit 30 is disposed downstream from the image forming unit 20, specifically, downstream from the belt loop 282. The ejection unit 30 includes a sheet ejection tray 31 on which the media 60 conveyed by the belt loop 282 is placed.

The colorimetry unit 40 performs colorimetry of the colorimetry chart 61 formed on the medium 60 by the image forming unit 20. The colorimetry unit 40 includes a colorimetric conveyance section 41, an environmental temperature detector 42, a medium heating section 43, a colorimetry section 44, and a second sampling tray 45.

The colorimetric conveyance section 41 conveys the medium 60 sent from the switching section 283 to the colorimetry position of the colorimetry unit 40. The colorimetric conveyance section 41 includes an introduction section 46 and a standby section 47 between the colorimetric conveyance unit 41 and the colorimetry section 44. The introduction section 46 conveys the medium 60 from the switching section 283 to the standby section 47. The standby section 47 causes the introduced medium 60 to stand by on the upstream of the colorimetry section 44. The introduction section 46 and the standby section 47 respectively have independent rollers and belts and can be driven separately.

The environmental temperature detector 42 detects an environmental temperature of the colorimetry unit 40. In the present embodiment, the cover part 48 covers substantially the entire body including the colorimetric conveyance section 41 and the colorimetry section 44. The environmental temperature detector 42 detects the temperature of the internal space of the cover part 48 in which the medium 60 is disposed, and transmits the temperature to the controller 50.

The medium heating section 43 heats the medium 60 on which the colorimetry chart 61 is formed. The medium heating section 43 may be, for example, a hot-air supplier (hot-air supplying heater) that supplies hot air by blowing hot air onto the medium 60. The medium heating section 43 may be an IR heater that irradiates the medium 60 with infrared rays. Furthermore, the medium heating section 43 may be a belt heater that heats a belt on which the medium 60 is placed and conveyed.

The medium heating section 43 is capable of heating to a temperature at least higher than the environmental temperature. However, the medium heating section 43 needs to heat the medium 60 within a temperature range in which the photocurable ink and the medium 60 are not discolored. The heating temperature of the medium heating section 43 can be measured as the surface temperature of the medium 60.

The colorimetry section 44 performs colorimetry on each patch 62 of the colorimetry chart 61. In the present embodiment, the colorimetry section 44 can measure the colors of all the patches 62 of the colorimetry chart 61. The colorimetric value of each patch 62 is acquired as, for example, a value quantified in the Lab color space.

The colorimetric value varies due to a color change caused by the photopolymerization initiator in the photocurable ink. In the present embodiment, each patch 62 of the colorimetry chart 61 is irradiated with light by the fixing section 25 of the image forming unit 20, and thus is yellowed over time.

FIG. 3 is a graph showing an example of color change in the photocurable ink after irradiation with light. The horizontal axis represents elapsed time after light irradiation in the fixing section 25, and the vertical axis represents the degree of yellowing detected by the amount of change in the colorimetric value.

A solid line A in FIG. 3 indicates a change when the medium 60 is heated by the medium heating section 43, and a dotted line B indicates a change when the medium 60 is not heated by the medium heating section 43. Both the solid line A and the dotted line B are results obtained by using the same photocurable ink. The vertical dash dot lines in FIG. 3 indicate elapsed times at which the respective colorimetric values can be regarded as stable.

As is clear from FIG. 3, the elapsed time until the colorimetric value is stabilized differs depending on the type of the photocurable ink and the temperature of the medium. In the change without heating indicated by the dotted line B in FIG. 3, about 10 minutes is required to elapsed until the colorimetric value is stabilized although it depends on the formulation of the photocurable ink. On the other hand, in the change with heating indicated by the solid line A, a certain time or more is required to be elapsed until stabilization though the time until stabilization can be shortened.

Therefore, with the colorimetry section 44 of the colorimetry unit 40 of the present embodiment, the controller 50 described later acquires a stable colorimetric value in each patch of the colorimetry chart 61 after the color change is stabilized.

The colorimetric value of each patch of the colorimetry chart 61 is transferred to the controller 50, and is used for color correction or the like of the image forming unit 20.

Back in FIG. 1, the second sampling tray 45 is a site where the medium 60 on which the colorimetry chart 61 is formed is ejected after the colorimetry, and is arranged on the downstream of the colorimetry section 44. The medium 60 on which the colorimetry has been performed by the colorimetry section 44 is transported to the second sampling tray 45 by the colorimetric conveyance section 41.

The operation of the colorimetry unit 40 is controlled by the controller 50 described later. The colorimetry unit 40 of the present embodiment can be operable even while the operation of the image forming unit 20 is stopped. For example, even when an error of any kind occurs in the image forming unit 20 and the operation is stopped, the colorimetry unit 40 continues the colorimetry of the medium 60 which has already been introduced.

The controller 50 includes a central processing unit (CPU), a read only memory (ROM), and a random access memory (RAM), which are hardware resources of a computer.

The CPU reads a predetermined program from the ROM, develops the program in the RAM, and integrally controls the operation of each component of the image forming apparatus 1 according to the developed program.

That is, the controller 50 of the present embodiment controls the operation of each of the sheet feeding unit 10, the image forming unit 20, the ejection unit 30, and the colorimetry unit 40.

The computer-readable recording medium that stores the program is not limited to the ROM, and for example, a portable recording medium such as a hard disk drive (HDD), a CD-ROM, or a DVD disk can be applied. The ROM and the portable recording medium are used as an example of a computer-readable non-transitory storage medium that stores a program to be executed by the controller 50.

In the operation control of the colorimetry unit 40, the controller 50 causes the colorimetry unit 40 to perform colorimetry of the colorimetry chart 61 after the color change time has elapsed from the time when the colorimetry chart 61 is irradiated with light.

The controller 50 controls the operation of the colorimetry unit 40 according to a colorimetry program.

The colorimetry program, which will be described later, includes a step of causing the medium 60 to stand by in correspondence with a color change time from light irradiation for the colorimetry unit 40.

The controller 50 can set a standby time corresponding to the color change time in advance. The controller 50 also causes the colorimetry unit 40 to stop conveyance by the colorimetric conveyance section 41 for a preset standby time.

The controller 50 can change the standby time according to the type of the photocurable ink. The types of the photocurable ink may be distinguished by, for example, the type and the amount of the photopolymerization initiator contained in the photocurable ink.

The controller 50 stores in advance, in a storage section (not illustrated), a table indicating a correlation between the type of the photocurable ink and the standby time from the light irradiation. When an operator inputs information capable of identifying the type of ink to the input section during activation of the image forming apparatus 1, the controller 50 can appropriately set the standby time of the colorimetry chart 61 in the colorimetry unit 40.

The standby time can be changed by the controller 50 according to the environmental temperature of the colorimetry unit 40. Furthermore, when the medium 60 is heated by the medium heating section 43, the standby time can be changed by the heating temperature of the medium heating section 43. When the environmental temperature or the heating temperature by the medium heating section 43 is high, the controller 50 can shorten the standby time because the curing reaction is promoted.

Furthermore, the controller 50 stores, in the storage section (not illustrated), in advance, a table indicating a correlation between the environment temperature and the standby time from light irradiation and a table indicating a correlation between the heating temperature of the medium heating section 43 and the standby time from light irradiation. The controller 50 can appropriately set the standby time of the colorimetry chart 61 by receiving and acquiring the information of the environmental temperature and the heating temperature.

After the standby of the colorimetry chart 61, the colorimetry program causes the colorimetry unit 40 to perform colorimetry of the colorimetry chart 61 and acquire colorimetric values of the colorimetry chart 61.

Next, a method of performing colorimetry of the colorimetry chart 61 in the colorimetry unit 40 will be described.

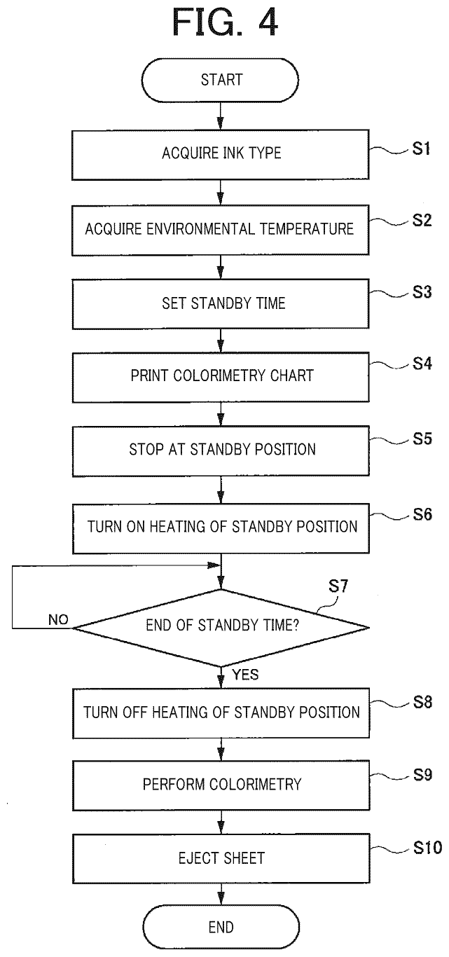

FIG. 4 is a flowchart showing a flow of the colorimetry method of executing the colorimetry program.

First, when the colorimetry of the colorimetry chart 61 is performed in the colorimetry unit 40, the controller 50 acquires the type of the photocurable ink (S1). The type of the photocurable ink includes the type and amount of the photopolymerization initiator. The type of photocurable ink may be input to the input section by an operator.

Next, the controller 50 acquires the environmental temperature from the information transmitted from the environmental temperature detector 42 (S2). Next, the controller 50 sets the standby time based on the type of the photocurable ink, the environmental temperature, and the heating temperature (S3).

On the other hand, the image forming unit 20 performs printing by forming the colorimetry chart 61 on the medium 60 before and after normal image formation or in the middle of image formation (S4). Then, the controller 50 starts the measurement of the standby time from the light irradiation of the fixing section 25 of the image forming unit 20.

Next, the controller 50 moves the medium 60 having the colorimetry chart 61 from the image forming unit 20 to the standby section 47 of the colorimetry unit 40 via the switching section 283 and the introduction section 46. Then, the controller 50 stops the medium 60 at the standby position of the standby section 47 and causes the medium 60 to stand by (S5).

In the standby section 47, the controller 50 turns on the medium heating section 43 to heat the standby position to a preset temperature, thereby heating the medium 60 having the colorimetry chart 61 (S6). The controller 50 maintains this state until the set standby time is elapsed (S7). Then, after the standby time of the medium 60 is elapsed, the controller 50 turns off the medium heating section 43 to end heating the standby position (S8).

Then, the controller 50 moves the medium 60 having the colorimetry chart 61 to the colorimetry section 44 by the colorimetric conveyance section 41. The colorimetry section 44 performs colorimetry of each patch of the colorimetry chart 61 and transmits the colorimetric values of each patch to the controller 50 (S9). The colorimetric value of each patch of the colorimetry chart 61 is used for color correction or the like of the image forming unit 20.

Thereafter, the colorimetric conveyance section 41 moves and ejects the medium 60 having the colorimetry chart 61 to the second sampling tray 45 (S10). The colorimetry of the medium 60 on which the colorimetric chart is formed is thereby finished.

According to the image forming apparatus 1 of the present embodiment as described above, the controller 50 allows the colorimetry unit 40 to perform colorimetry after the color change time has elapsed from the irradiation of the colorimetry chart 61 with light. Therefore, the colorimetry unit 40 can acquire the colorimetric value of the colorimetry chart 61 after the color change of the colorimetry chart 61 is stabilized. As a result, the colorimetry accuracy of the colorimetry chart 61 is improved.

The photocurable ink according to the present embodiment is an ink containing a photopolymerization initiator. The colorimetry unit 40 performs colorimetry after the elapse of the color change time. Therefore, even when a photocurable ink containing a photopolymerization initiator is used, the colorimetry unit 40 can prevent the accuracy of colorimetric values from deteriorating due to a color change, such as yellowing, of the colorimetry chart 61 caused by the photopolymerization initiator.

In the image forming apparatus 1, the controller 50 causes the colorimetry chart 61 to stand by in response to the lapse of the color change time, and then causes the colorimetry unit 40 to measure the color of the colorimetry chart 61. Therefore, the colorimetry unit 40 can easily acquire the colorimetric values of the colorimetry chart 61 after the color change of the colorimetry chart 61 is stabilized.

In the present embodiment, the colorimetry unit 40 includes the colorimetric conveyance section 41 that conveys the colorimetry chart 61 to the colorimetry position. In addition, the controller 50 causes the colorimetric conveyance section 41 to stop conveyance in accordance with a preset color change time. Therefore, the colorimetric conveyance section 41 can stop the colorimetric chart 61 before colorimetry and cause the colorimetry chart 61 to stand by. The colorimetry unit 40 can thereby easily secure the standby time corresponding to the color change time.

The controller 50 of the present embodiment can set a standby time corresponding to the color change time. The standby time can be changed according to the type of the photocurable ink.

Thus, the controller 50 can appropriately adjust the standby time in accordance with the color change time for various types of photocurable ink, thereby enabling the colorimetry unit 40 to appropriately perform colorimetry. The controller 50 can thereby easily ensure the colorimetry accuracy.

Furthermore, the controller 50 can change the standby time according to the environmental temperature of the colorimetry unit 40.

Thus, the controller 50 can appropriately adjust the standby time in accordance with the color change time of the photocurable ink at the environmental temperature, thereby enabling the colorimetry unit 40 to appropriately perform colorimetry. Therefore, the controller 50 can easily shorten the colorimetry time of the colorimetry chart 61 while ensuring the colorimetry accuracy.

Furthermore, the colorimetry unit 40 includes the medium heating section 43 that heats the medium 60 having the colorimetry chart 61. The controller 50 can change the standby time according to the heating temperature of the medium heating section 43.

Therefore, the medium heating section 43 can accelerate the photocuring reaction according to the heating temperature to shorten the color change time. As the controller 50 can appropriately adjust the standby time in accordance with the color change time at the heating temperature, the controller 50 can cause the colorimetry unit 40 to appropriately perform colorimetry. Furthermore, the controller 50 can shorten the colorimetry time of the colorimetry chart 61 while securing the colorimetry accuracy.

The controller 50 according to the present embodiment can operate the colorimetry unit 40 while the operation of the image forming unit 20 is stopped. Therefore, even when the image forming unit 20 is stopped due to various errors, the colorimetry of the colorimetry chart 61 can be continuously performed. The colorimetry unit 40 can thereby efficiently perform colorimetry of the colorimetry chart 61.

The image forming apparatus 1 of the present embodiment includes the ejection unit 30 for ejecting the medium 60 on which an image has been formed on the downstream of the image forming unit 20. In the delivery section 28 which is an ejection path between the image forming unit 20 and the ejection unit 30, a first sampling tray 32 and a second sampling tray 45 are provided so as to be branched from the ejection path.

Part of the media 60 ejected to the ejection unit 30 are ejected to the first sampling tray 32. The medium 60 on which the colorimetry chart 61 is formed is ejected to the second sampling tray 45 after the colorimetry.

In this way, the controller 50 can separately eject the media 60 which are not ejected to the ejection unit 30 and the media 60 which are ejected to the ejection unit 30. Furthermore, the controller 50 can separately eject the medium 60 on which the colorimetry chart 61 is formed and the other media 60 from among the media 60 not to be ejected to the ejection unit 30 to the different sampling trays 32 and 45. Therefore, the controller 50 can easily process the medium 60 after the image formation.

### Modification Example of First Embodiment

In the image forming apparatus and the colorimetry method according to the first embodiment, the controller 50 causes the medium 60 to wait by stopping the medium 60 at the standby position of the standby section 47, but the invention is not limited thereto. The controller 50 may set the time from the light irradiation of the fixing section 25 of the image forming unit 20 to the colorimetry to be the standby time set in advance.

For example, the controller 50 may adjust the conveyance speed of the colorimetric conveyance section 41 to be decreased in accordance with the preset color change time. The conveyance speed can also be set by an operator inputting it to the input section.

It is thereby possible for the colorimetry unit 40 before colorimetry to adjust the time up to the conveyance to the conveyance position. Therefore, the colorimetry unit 40 can cause the medium 60 having the colorimetry chart 61 before colorimetry to stand by in the colorimetric conveyance section 41 without stopping the medium 60 in the middle of conveyance. Even in such a method, the controller 50 can improve the colorimetry accuracy by securing the standby time corresponding to the color change time before the colorimetry.

### Other Modification Examples of First Embodiment

Further, in the first embodiment, the controller 50 sets the standby time based on the information of the environmental temperature and the heating temperature, but the present invention is not particularly limited thereto. For example, the controller 50 may set the standby time depending on only the type of ink without depending on these pieces of information. Furthermore, the controller 50 can also set the standby time based on the type of ink and either one of the environmental temperature and the heating temperature.

### Second Embodiment

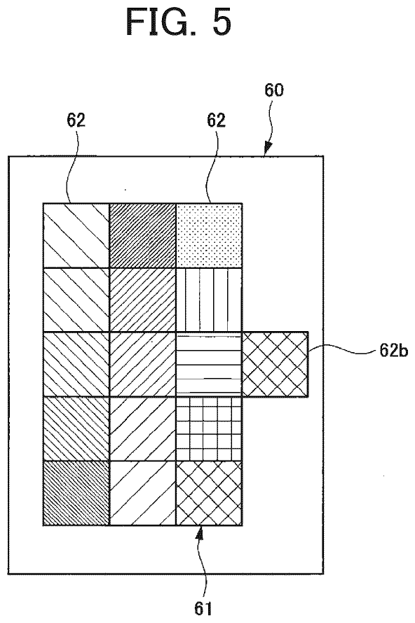

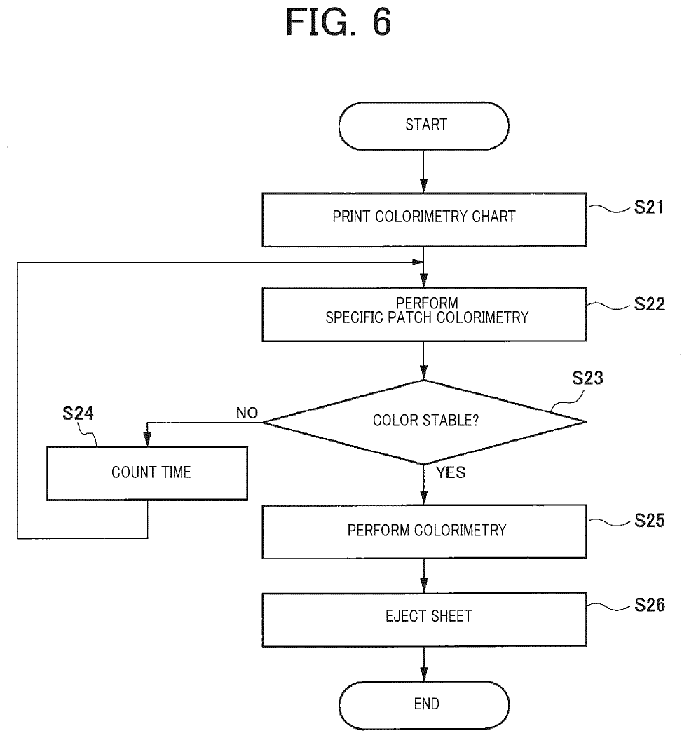

Next, a second embodiment of the present invention will be described. FIG. 5 is a front view of a colorimetry chart 61 used in the colorimetry method of the second embodiment. FIG. 6 is a flowchart showing a flow of a colorimetry method executed by a colorimetry program in the second embodiment.

The second embodiment is different from the first embodiment in the configuration of the medium 60 on which the colorimetry chart 61 is formed and the colorimetry unit 40. Furthermore, the colorimetry method in the second embodiment is different from that in the first embodiment. The rest is similar to the first embodiment.

As shown in FIG. 5, a medium 60 formed in the second embodiment has a colorimetry chart 61 and a color change detection patch 62b. The colorimetry chart 61 is the same chart as the colorimetry chart in the first embodiment, and is subjected to colorimetry in the colorimetry section 44, and the colorimetry result is used for color correction or the like of the image forming unit 20. The color change detection patch 62b is a patch 62 provided in a region different from the region of the colorimetry chart 61. The medium 60 of the present embodiment has one color change detection patch 62b adjacent to the colorimetry chart 61. The colorimetry chart 61 and the color change detection patch 62b are formed at the same time by the image forming unit 20.

The image forming apparatus 1 of the second embodiment can also be described with reference to the schematic view showing the entire configuration shown in FIG. 1.

The colorimetry unit 40 of the second embodiment has a device configuration capable of repeatedly performing colorimetry on the same patch 62 of a part of the medium 60 having the colorimetry chart 61.

To be specific, unlike the colorimetry unit 40 of the first embodiment, the colorimetry unit 40 of the second embodiment has a device configuration capable of repeatedly performing colorimetry of the color change detection patch 62b.

The colorimetry unit 40 includes, in the colorimetry section 44, a chart colorimetry head 44a to perform colorimetry of the colorimetry chart 61, similarly to the first embodiment. In addition, the colorimetry unit 40 according to the second embodiment includes, in the standby section 47, a color change detection colorimetry head 44b that can repeatedly perform colorimetry of the color change detection patch 62b.

The chart colorimetry head 44a is installed in the colorimetry section 44. The chart colorimetry head 44a is installed so as to be relatively movable with respect to the colorimetry chart 61 in order to perform colorimetry of the large number of patches 62 of the colorimetry chart 61.

The color change detection colorimetry head 44b is fixedly installed at a specific position in the standby section 47. The specific position where the color change detection colorimetry head 44b is installed is a position facing the color change detection patch 62b when the medium 60 is stopped in the standby section 47. Furthermore, when the medium moves without stopping in the standby section 47, the specific position where the color change detection colorimetry head 44b is installed is a position facing to the movement path of the color change detection patch 62b.

The controller 50 according to the second embodiment controls the operation of the colorimetry unit 40 according to a colorimetry program.

Although the colorimetry program will be described later, the colorimetry program includes a step of determining the lapse of the color change time based on a change in the detected colorimetric value by causing the colorimetry unit 40 to repeatedly perform colorimetry of the color change detection patch 62b. When the change in the colorimetric value of the color change detection patch 62b reaches a predetermined range, the controller 50 determines the lapse of the color change time since the light irradiation. After the determination, the controller 50 causes the colorimetric conveyance section 41 to move the medium 60 to the colorimetry section 44 and acquire the colorimetric value of the colorimetry chart 61.

Hereinafter, a method of performing colorimetry of the colorimetry chart 61 by the colorimetry unit 40 of the second embodiment will be described.

As shown in FIG. 6, in order to perform colorimetry of the colorimetry chart 61 in the colorimetry unit 40, first, the image forming unit 20 forms and prints the colorimetry chart 61 and the color change detection patch 62b on the medium 60 (S21).

The controller 50 moves the medium 60, on which the colorimetry chart 61 and the color change detection patch 62b have been formed, from the image forming unit 20 to the standby section 47 of the colorimetry unit 40 via the switching section 283 and the introduction section 46. In the standby section 47, the medium 60 stands by in a stopped state.

The controller 50 causes the color change detection colorimetry head 44b to perform colorimetry of the color change detection patch 62b on the medium 60 in the standby section 47 (S22). The controller 50 stores the colorimetric value at that time in the storage section (not illustrated).

Next, the controller 50 compares the measured colorimetric value with the previous colorimetric value to determine the stability of the color change (S23). At the first time, since the previous colorimetric value does not exist and the measured value is compared with the value set by default, the controller 50 always determines that the color change is not stable.

When it is determined that the color change is not stable, the controller 50 counts a predetermined time set in advance. The predetermined time to be counted (S24) may be significantly shorter than the standby time in the first embodiment.

Thereafter, the controller 50 causes the color change detection colorimetry head 44b to perform colorimetry of the color change detection patch 62b again (S22), and compares the measured value with the previous colorimetric value to determine the stability of the color change (S23).

The controller 50 repeatedly performs colorimetry (S22) of the color change detection patch 62b, compares the measured value with the previous colorimetric value (S23), and counts the predetermined time (S24). Then, the controller 50 acquires a change between the measured colorimetric value and the previous colorimetric value stored in the storage section every time.

When the change between the measured colorimetric value and the previous colorimetric value reaches a predetermined range, the controller 50 determines that the color change is stable (S23).

After the stabilization, the controller 50 causes the colorimetric conveyance section 41 to move the medium 60 to the colorimetry section 44. The colorimetry section 44 performs colorimetry on each patch 62 of the colorimetry chart 61, and transmits the colorimetric value of each patch 62 to the controller 50 (S25). The colorimetric value of each patch 62 of the colorimetry chart 61 is used for color correction or the like of the image forming unit 20.

Thereafter, the controller 50 moves and ejects the medium 60 having the colorimetry chart 61 to the second sampling tray 45 by the colorimetric conveyance section 41 (S26). The controller 50 can thereby end the colorimetry of the medium 60 on which the colorimetry chart 61 and the color change detection patch 62b are formed.

The image forming apparatus 1, the colorimetry method, and the colorimetry program of the second embodiment as described above can also bring about similar advantageous effects with similar configurations to those of the first embodiment.

Furthermore, in the second embodiment, the colorimetry unit 40 can repeatedly perform colorimetry of the same color change detection patch 62b on the medium 60 on which the colorimetry chart 61 is formed. Then, the controller 50 causes the colorimetry unit 40 to repeatedly perform colorimetry, and determines whether the color change time has elapsed based on a change in the colorimetric value of the same color change detection patch 62b.

Therefore, the controller 50 can reliably determine that the color change has become stable, and can reliably improve the colorimetry accuracy of the colorimetry chart 61.

The controller 50 of the second embodiment acquires the colorimetric value of the colorimetry chart 61 after the change in the colorimetric value of the same color change detection patch 62b reaches the predetermined range.

Therefore, after the color change of the colorimetry chart 61 is stabilized, the controller 50 causes the colorimetry unit 40 to easily acquire the colorimetric values of the colorimetry chart 61.

Furthermore, the colorimetry unit 40 according to the second embodiment includes the chart colorimetry head 44a and the color change detection colorimetry head 44b that repeatedly performs colorimetry on the same color change detection patch 62b. Therefore, the controller 50 can prevent an increase in the frequency of use of the chart colorimetry head 44a of the colorimetry unit 40 for detecting the stability of the color change. As a result, the controller 50 can prevent a part of the chart colorimetry head 44a from being deteriorated or the accuracy from being lowered, and can keep the colorimetry accuracy high.

The medium 60 of the second embodiment includes the colorimetry chart 61 and the color change detection patch 62b provided in a region different from the colorimetry chart 61.

With this configuration, the colorimetry unit 40 can include the dedicated color change detection colorimetry head 44b for performing colorimetry of the color change detection patch 62b. Furthermore, in the colorimetry unit 40, the color change detection colorimetry head 44b can be fixedly installed without being moved to a specific position of the colorimetry unit 40. Therefore, a mechanism for moving the color change detection colorimetry head 44b is unnecessary, and the device configuration of the colorimetry unit 40 can be simplified.

### Modification Example of Second Embodiment

In the second embodiment described above, the medium 60 includes the colorimetry chart 61 and the color change detection patch 62b. The color change detection colorimetry head 44b is provided in the standby section 47 to perform colorimetry of the color change detection patch 62b. However, the second embodiment is not limited thereto as long as it is within the scope of this disclosure.

For example, the medium 60 may not include the color change detection patch 62b and may include the colorimetry chart 61 as in the first embodiment. In such a case, the controller 50 can cause the color change detection colorimetry head 44b in the standby section 47 to repeatedly perform colorimetry of the same patch 62 of a part of the colorimetry chart. Then, after the change in the colorimetric value of the same patch 62 reaches the predetermined range, the controller 50 can move the medium 60 to the colorimetry section 44 and cause the colorimetry section 44 to perform colorimetry of the colorimetry chart 61.

Furthermore, the standby section 47 of the colorimetry unit 40 may not include the color change detection colorimetry head 44b. In that case, if the medium 60 having the colorimetry chart 61 and the color change detection patch 62b is used, the colorimetry section 44 may have the chart colorimetry head 44a and the color change detection colorimetry head 44b.

Then, since the colorimetry unit 40 does not have to include the standby section 47, the device configuration can be simplified.

If the medium 60 does not have the color change detection patch 62b but has the colorimetry chart 61, the controller 50 may cause the chart colorimetry head 44a of the colorimetry section 44 to repeatedly perform colorimetry of a part of the same patch 62 in the colorimetric chart.

In this way, the second embodiment can prevent the device configuration from becoming complicated even when the colorimetry unit 40 repeatedly performs colorimetry to detect the stability of the color change.

In the second embodiment and the modification examples thereof, the colorimetric conveyance section 41 moves the medium 60 in one direction from the standby section 47 to the colorimetry section 44, but the colorimetric conveyance section 41 may move the medium 60 in both directions between the standby section 47 and the colorimetry unit 44. In this case, the controller 50 can return the medium 60 from the colorimetry section 44 to the standby section 47 to stand by after the colorimetry of the color change detection patch 62b. The controller 50 can cause the colorimetry section 44 to repeatedly move back and forth between the colorimetry section 44 and the standby section 47 to perform colorimetry of the color change detection patch 62b until the color change of the color change detection patch 62b measured by the colorimetry section 44 is stabilized.

In such a case, the standby section 47 may further have a size that allows a plurality of the media 60 to stand by.

The first embodiment and the second embodiment described above can be appropriately modified in other respects as well without departing from the spirit and scope of the invention described in the claims of the present disclosure.

For example, each of the above-described embodiments is described with the example in which the controller 50 controls the operation of the colorimetry unit 40 as well as the entire apparatus. However, the controller of the colorimetry unit 40 may be configured separately from the controller of other parts such as the image forming unit 20.

In addition, the colorimetry of the colorimetry chart 61 in each of the embodiments described above can be combined. For example, first, as in the first embodiment described above, the controller 50 causes the colorimetry chart 61 to stand by for a preset color change time. Thereafter, as in the second embodiment described above, the controller 50 can repeatedly perform colorimetry of the same color change detection patch 62b, determine that the color change is reliably stabilized, and then perform colorimetry of the colorimetry chart 61. In that case, in the flow of the colorimetry methods in FIGS. 4 and 6, the controller 50 sets a standby time (S1 to S3), causes the colorimetry chart 61 to stand by (S4 to S8), then determines the color stability of the color change detection patch 62b (S22 to S24), and performs colorimetry of the colorimetry chart 61. In this way, even if the controller 50 sets an inappropriate standby time or simply sets a standby time regardless of conditions, colorimetry can be reliably performed after color stabilization.

Although embodiments of the present invention have been described and shown in detail, the disclosed embodiments are made for purposes of illustration and example only and not limitation. The scope of the present invention should be interpreted by terms of the appended claims.

What is claimed is:

1. An image forming apparatus comprising:
an image forming unit that forms an image on a medium with a photocurable ink;
a colorimetry unit that performs colorimetry of a colorimetry chart formed on the medium by the image forming unit; and
a hardware processor that causes the colorimetry of the colorimetry chart to be performed after elapse of a color change time since irradiation of the colorimetry chart with light.

2. The image forming apparatus according to claim 1,
wherein the hardware processor causes the colorimetry chart to stand by in accordance with the elapse of the color change time, and then causes the colorimetry of the colorimetric chart to be performed.

3. The image forming apparatus according to claim 2,
wherein the colorimetry unit includes a colorimetric conveyance section that conveys the colorimetric chart to a colorimetry position;
wherein the hardware processor causes the colorimetric conveyance section to stop conveyance in accordance with the color change time set in advance.

4. The image forming apparatus according to claim 2,
wherein the colorimetry unit includes a colorimetric conveyance section that conveys the colorimetric chart to a colorimetry position;
wherein the hardware processor adjusts a conveyance speed of the colorimetric conveyance section in accordance with the color change time set in advance.

5. The image forming apparatus according to claim 2,
wherein the hardware processor can set a standby time corresponding to the color change time, wherein the standby time is changeable according to a type of the photocurable ink.

6. The image forming apparatus according to claim 2,
wherein the hardware processor can set a standby time corresponding to the color change time;
wherein the standby time is changeable according to an environmental temperature of the colorimetry unit.

7. The image forming apparatus according to claim 2,
wherein the colorimetry unit includes a medium heating section to heat the medium having the colorimetry chart,
wherein the hardware processor can set a standby time corresponding to the color change time,
wherein the standby time is changeable according to a heating temperature of the medium heating section.

8. The image forming apparatus according to claim 7,
wherein the medium heating section is a hot-air supplying heater that supplies hot air to the medium, an IR heater that irradiates the medium with infrared rays, or a belt heater on which the medium is placed and conveyed.

9. The image forming apparatus according to claim 1,
wherein the colorimetry unit can repeatedly perform colorimetry of a same patch of at least part of the medium,
wherein the hardware processor causes the colorimetry unit to repeatedly perform the colorimetry of the same patch, and determines whether the color change time has elapsed based on a change in a colorimetric value of the same patch.

10. The image forming apparatus according to claim 9,
wherein the hardware processor causes a colorimetric value of the colorimetry chart to be acquired after the change in the colorimetric value of the same patch reaches a predetermined range.

11. The image forming apparatus according to claim 9,
wherein the colorimetry unit includes:
a chart colorimetry head that performs the colorimetry of the colorimetry chart; and
a color change detection colorimetry head that can repeatedly perform the colorimetry of the same patch.

12. The image forming apparatus according to claim 9,
wherein the colorimetry unit includes a chart colorimetry section that performs the colorimetry of the colorimetry chart;
wherein the chart colorimetry section can repeatedly perform the colorimetry of the same patch.

13. The image forming apparatus according to claim 11,
wherein the medium is provided with the colorimetry chart and a color change detection patch provided in a region different from a region of the colorimetric chart.

14. The image forming apparatus according to claim 1,
wherein the hardware processor can operate the colorimetry unit while an operation of the image forming unit is stopped.

15. The image forming apparatus according to claim 1, further comprising:
an ejection unit for ejecting the medium on which an image has been formed on a downstream of the image forming unit,
wherein the medium includes a plurality of media,
wherein from an ejection path between the image forming unit and the ejection unit branched are:
a first sampling tray for ejecting a part of the plurality of media ejected to the ejection unit; and
a second sampling tray for ejecting after the colorimetry the medium on which the colorimetry chart is formed.

16. The image forming apparatus according to claim 1,
wherein the photocurable ink contains a photopolymerization initiator.

17. A colorimetry method of performing colorimetry of a colorimetry chart formed on a medium with a photocurable ink, comprising:
irradiating the colorimetric chart with light;
causing the medium to stand by for a standby time set in advance so as to correspond to a color change time from the irradiation of the colorimetry chart; and
performing colorimetry of the colorimetry chart after lapse of the standby time.

18. A colorimetry method of performing colorimetry of a colorimetry chart formed on a medium with a photocurable ink, comprising:
irradiating the colorimetric chart with light;
acquiring a change in a colorimetric value of a same patch of at least part of the colorimetry chart by repeatedly performing colorimetry on the same patch; and
performing colorimetry of the colorimetry chart after the change in the colorimetric value reaches a predetermined range.
